(19) United States
(12) Patent Application Publication
(10) Pub. No.: US 2010/0176034 A1
(43) Pub. Date: Jul. 15, 2010

(54) POWDER SEPARATOR AND METHOD OF POWDER SEPARATION

(75) Inventors: Masafumi Kikuchi, Kanagawa (JP); Akio Koyama, Kanagawa (JP); Kichinosuke Amimoto, Tokyo (JP); Takao Nishishita, Tokyo (JP); Yutaka Akahoshi, Tokyo (JP); Kazuko Ito, Tokyo (JP)

Correspondence Address: GREENBLUM & BERNSTEIN, P.L.C., 1950 ROLAND CLARKE PLACE, RESTON, VA, 20191, US

(73) Assignee: MEIJI UNIVERSITY LEGAL PERSON, Tokyo (JP)

(21) Appl. No.: 12/088,181

(22) PCT Filed: Feb. 8, 2007
(86) PCT No.: PCT/JP2007/052183

§ 371 Date: Mar. 26, 2008

(30) Foreign Application Priority Data
Feb. 17, 2006 (JP) P2006-041274

(51) Int. Cl. B07B 4/08; B07B 1/28; B07B 9/00

(52) U.S. Cl. 209/3.1; 209/44.2; 209/44

(57) ABSTRACT

A powder separation apparatus and method are provided so as to be able to accurately separate a raw powder material. This apparatus has a container into which a raw powder material containing a heavy powder and a light powder, and medium particles having a larger particle size than the raw powder material, are supplied; a container shaker for shaking the container; and a gas blower unit for blowing a gas into an interior of a medium particle layer in the container to discharge the light powder with the gas to the outside of the medium particle layer.

### TECHNICAL FIELD

The present invention relates to a powder separation apparatus and a powder separation method for separating a raw powder material to be separated.

### BACKGROUND ART

As recycling of materials gathers momentum in recent years, there are demands for efficiently recycling composite materials comprising of different types of materials, e.g., resin wallpapers each comprising of a laminate of a resin layer of PVC or the like and a backing paper (pulp fiber layer), and tile carpets, soundproof sheets, waterproof sheets, construction safety nets, etc. each comprising of a laminate of a resin layer of PVC or the like and a nylon or polyester fiber layer, or comprising of a sandwich structure in which a fiber layer is sandwiched between resin layers. For recycling such composite materials, it is necessary to powder the composite materials and separate the powdered materials according to kinds of materials.

For example, when a composite material containing a resin layer and a fiber layer is finely pulverized, we obtain a mixture of granular resin powder particles resulting from the resin layer, and fibers. For recycling them, it is necessary to accurately separate the resin powder particles being relatively heavy powder, from the fibers being light powder.

Various separators such as wind classifiers and fluidized-bed classifiers are known as means for accurately separating the mixture containing the heavy powder and light powder. (Reference is made, for example, to Patent Documents below)

Patent Document 1: Japanese Patent Application Laid-open No. 2004-305929

Patent Document 2: Japanese Patent Application Laid-open No. 2003-127140

Patent Document 3: Japanese Patent Application Laid-open No. 11-244785

Patent Document 4: Japanese Patent Application Laid-open No. 2003-320532

Patent Document 5: Japanese Patent Application Laid-open No. 2000-61398

### DISCLOSURE OF THE INVENTION

### Problem to be Solved by the Invention

It was, however, found by the inventors' research that the fibers were easy to adhere to the resin powder and also easy to adhere to each other as get tangled together and that it was thus difficult to accurately separate them by the conventional separators. This tendency became more prominent, particularly, when the composite material was preliminarily powdered to the particle sizes of 300 μm or smaller order by cutting, pulverization, etc., in order to fully separate mechanical bonds between the fibers and the resin powder prior to separation.

The present invention has been accomplished in view of the above problem and an object of the present invention is to provide a powder separation apparatus and method capable of accurately separating a raw powder material containing a light powder and a heavy powder.

### Means for Solving the Problem

A powder separation apparatus according to the present invention comprises a container into which a raw powder material containing a heavy powder and a light powder, and medium particles having a larger particle size than the raw powder material, are supplied;

a container shaker for shaking the container to fluidize the medium particles; and

a gas blower unit for blowing a gas into an interior of a layer of the medium particles in the container to discharge the light powder with the gas to the outside of the layer of the medium particles.

A powder separation method according to the present invention comprises a step of vibrating a raw powder material containing a heavy powder and a light powder, and medium particles having a larger particle size than the raw powder material, in a container and blowing a gas into an interior of a layer of the medium particles in the container to discharge the light powder with the gas to the outside of the layer of the medium particles.

According to the present invention, the medium particles in the container are vibrated to flow, and this motion of the medium particles breaks adhesion between particles of the raw powder material, e.g., adhesion between particles of the light powder and adhesion between the light powder and the heavy powder. Then the flow of the gas blown from the gas blower unit into the medium particle layer causes the light powder relatively easier to fly off in the raw powder material, to be discharged with the gas to the outside of the medium particle layer. This allows the raw powder material to be accurately separated into the light powder and the heavy powder.

Preferably, the apparatus further comprises a medium particle circulator for discharging the medium particles from one end side in the container to the outside of the container and for supplying the medium particles discharged from the container, to the other end side in the container to form a unidirectional flow of the medium particles in the container.

This generates the unidirectional flow of the medium particles whereby a residence time of the raw powder material can be controlled, so as to enable more accurate separation.

Preferably, the gas blower unit has a gas blowing tube a nozzle of which is inserted in the layer of the medium particles. This configuration is suitable because the light powder can be discharged from any location to the outside of the medium particle layer.

Preferably, the gas blower unit has a plurality of gas blowing tubes a nozzle of each of which is inserted in the layer of the medium particles, and the plurality of gas blowing tubes are juxtaposed in a direction of the unidirectional flow of the medium particles and/or juxtaposed in a direction intersecting with the direction of the unidirectional flow of the medium particles.

For example, when the gas blowing tubes are juxtaposed in the direction of the unidirectional flow, the light powder can be discharged in multiple stages from the medium particle layer, which increases efficiency of separation. When they are juxtaposed in the direction intersecting with the direction of the unidirectional flow, the separation can be suitably carried out in the container with a wide width, which facilitates increase in disposal amount.

Preferably, the apparatus further comprises a gas blowing tube shaker for shaking the gas blowing tube.

This configuration allows the medium particles to be sufficiently fluidized, particularly, in the gas-blown region, which enables more efficient separation of the light powder.

Preferably, a bottom part on one end side of the container is provided with a sieve, e.g., a mesh or a perforated plate, for preventing the medium particles from passing and for permitting the raw powder material to pass.

This configuration makes it easier to separate the heavy powder after the light powder has been separated from the medium particles.

Preferably, the sieve comprises a plurality of sieve stages mesh sizes or opening sizes of which increase from upstream to downstream of the unidirectional flow of the medium particles.

This configuration enables the heavy powder to be separated and recovered according to particle sizes.

Preferably, a bottom part of the container is a ramp inclined from upstream to downstream of the unidirectional flow of the medium particles.

This configuration facilitates formation of the unidirectional flow of the medium particles.

On the other hand, the apparatus is also preferably configured as follows: a sieve for preventing the medium particles from passing and for permitting the raw powder material to pass is provided in the container, and the gas blower unit supplies the gas upward through the sieve into the layer of the medium particles on the sieve.

This configuration also permits the light powder to be separated and discharged with the gas to above the medium particles and permits the heavy powder to drop to be separated to below the medium particles.

In this case, preferably, the container further has a sieve a mesh size of which is smaller than that of the aforementioned sieve, below it. This enables classification of the heavy powder.

Preferably, the raw powder material is a powder of 300 μm or less containing a resin powder as the heavy powder and a fiber as the light powder, e.g., resin fiber, glass fiber, or pulp fiber.

In this case, the resin powder and the fiber are suitably separated as the heavy powder and as the light powder, respectively. Such powder is obtained by powdering a composite material containing the resin layer and the fiber layer (including a pulp layer). This is particularly effective in cases where it is difficult for the conventional separation methods to separate the raw powder material, e.g., in the case where the raw powder material contains the light powder 5 weight % or less, or, on the contrary, in the case where the raw powder material contains the heavy powder 5 weight % or less.

Preferably, the apparatus comprises a bug filter for collecting the light powder in the gas discharged from the container.

This facilitates collection of the light powder.

Preferably, the apparatus further comprises a crusher for preliminarily crushing the raw powder material to be charged into the container.

The composite powder containing the light powder and the heavy powder (e.g., 300 μm or less) is normally extremely easy to aggregate and it is difficult to separate them in an aggregate state. Therefore, when this aggregate is crushed and then the crushed particles are put into the container, it becomes feasible to implement stably highly-accurate separation.

Preferably, the apparatus further comprises a charged plate for electrostatically adsorbing the powder discharged to the outside of the layer of the medium particles by the gas from the gas blower unit.

In this case, it becomes easier to recover the light powder.

### Effect of the Invention

The present invention provides the powder separation apparatus and method capable of accurately separating the raw powder material.

### BRIEF DESCRIPTION OF THE DRAWINGS

FIG. 1 is a schematic sectional view to illustrate a powder separation apparatus according to the first embodiment.

FIG. 2 is a top plan view of the interior of a container 30 in FIG. 1.

FIG. 3 is a schematic sectional view to illustrate a powder separation apparatus according to the second embodiment.

FIG. 4 is a schematic sectional view to illustrate a powder separation apparatus according to the third embodiment.

FIG. 5 is a top plan view of a region near the container 30 in FIG. 4.

FIG. 6 is a schematic sectional view to illustrate a powder separation apparatus according to the fourth embodiment.

FIG. 7 is a schematic sectional view to illustrate a powder separation apparatus according to the fifth embodiment.

FIG. 8 is a microphotograph of a raw powder material in an example.

FIG. 9 is a microphotograph of a light powder after separated out in the example.

FIG. 10 is a microphotograph of a heavy powder after separated out in the example.

### DESCRIPTION OF REFERENCE SYMBOLS

20 crusher; 4 raw powder material; 32a, 32b, 32c meshes (perforated plates); 30 container; 40 gas blower unit; 42 gas blowing tubes; 43 blowing tube shaker; 50 container shaker; 60 medium particle circulator; 64 medium particles; 70 bug filter; 80 charged plate; 100, 101, 102, 103, 104 powder separation apparatus.

### BEST MODE FOR CARRYING OUT THE INVENTION

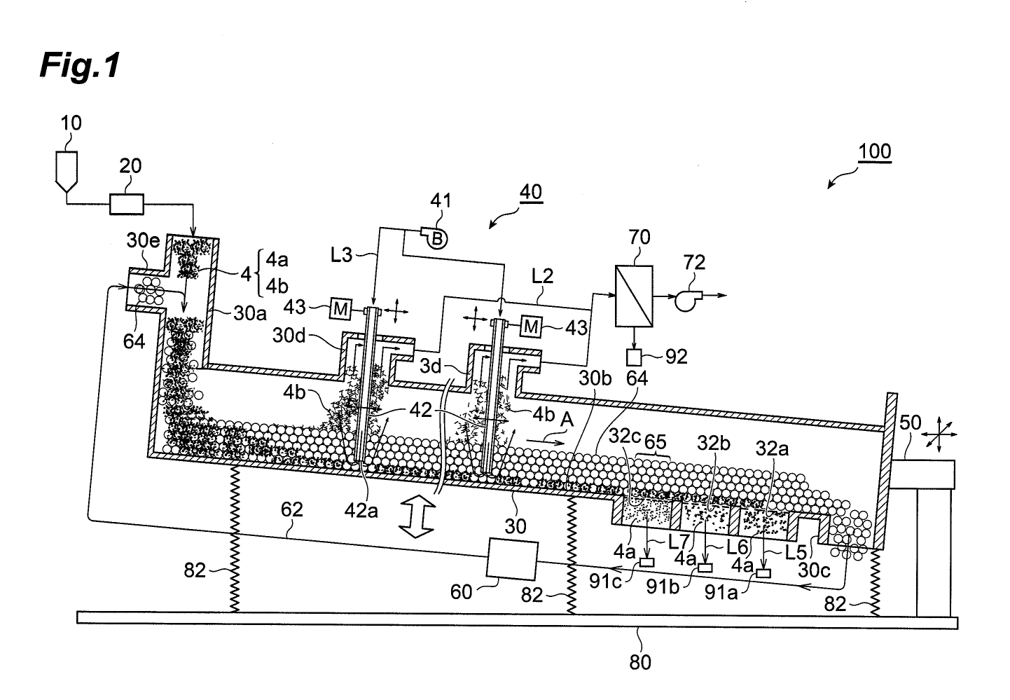

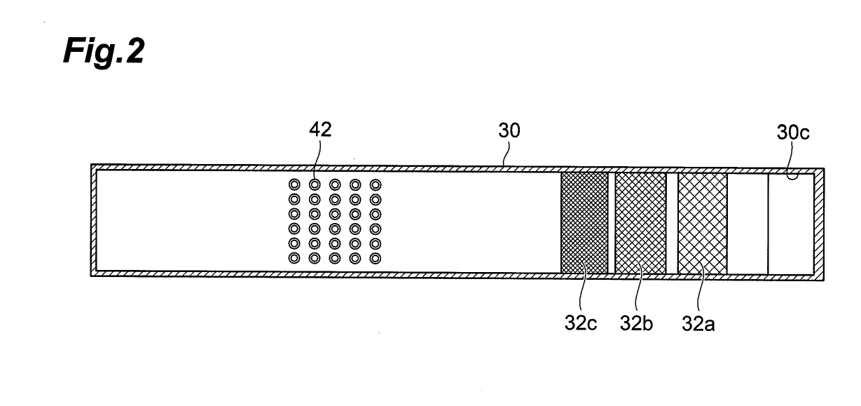

The first embodiment of the present invention will be described below with reference to FIGS. 1 and 2. The powder separation apparatus 100 of the present embodiment is comprised mainly of a raw material hopper 10, a crusher 20, a separation vessel (container) 30, a gas blower unit 40, a container shaker (container shaking unit) 50, and a medium particle circulator 60.

The raw material hopper 10 stores a raw powder material 4. The raw powder material is a powder mixture containing a light powder being relatively light and a heavy powder being relatively heavy. In the present embodiment, the raw powder material used is, particularly, a mixture of resin powder 4a and fiber 4b obtained by powdering a composite material which was compounded by lamination or the like of a resin layer of PVC or the like and a fiber layer of paper (pulp fiber), resin fiber, glass fiber, or the like. Specific examples of the raw powder material include powders of composite materials such as resin wallpapers each comprising of a laminate of a resin layer of PVC or the like and a backing paper (pulp fiber), and tile carpets, soundproof sheets, waterproof sheets, construction safety nets, etc. each comprising of a laminate of a resin layer of PVC or the like and a nylon or polyester resin fiber layer, or comprising of a sandwich structure in which a resin fiber layer is sandwiched between resin sheets of PVC or the like. In this case, the raw powder material 4 is preferably one obtained by powdering any one of the above-described composite materials to 300 μm or less and, more preferably, to 200 μm or less, because it is easy for the resin and fiber to be preliminarily brought into a mechanically separated state. The resin constituting the resin layer is not limited to PVC, but the resin may be any synthetic resin of olefin or the like or any rubber resin or the like. There are no particular restrictions on the material of fiber, either, and it may be any kind of pulp, resin, and so on. The composite material can be readily powdered to 300 μm or less by means of a well-known cutting device or the like.

The crusher 20 crushes the raw powder material 4 supplied from the raw material hopper 10. Particularly, adhesion is likely to occur between resin powder 4a and fiber 4b and between fibers 4b, and therefore separation in the container 30 can be particularly accurately performed after the raw powder material 4 has been crushed prior to charge into the container 30.

There are no particular restrictions on a specific configuration of the crusher 20, but any device that implements crushing or fiberizing action by agitating the raw powder material 4 by rotor blades or the like can be suitably used, e.g., like the crushing device as described in the fourth embodiment.

The container 30 is of a horizontally long box shape and is arranged as inclined with one longitudinal end (right end in FIG. 1) of a bottom surface 30b being lower and the other longitudinal end (left side in FIG. 1) of the bottom surface 30b being upper. As described below, medium particles 64 flow in a constant direction (direction A in the drawing) from left to right in FIG. 1 in accordance to the inclination in the container 30.

The upper part of the container 30 on one end side (left end side in FIG. 1) is provided with an inlet port 30a for receiving the raw powder material 4 from the crusher 20 and a supply port 30e for receiving the medium particles 64 from the medium particle circulator 60.

A discharge port 30c for extracting the medium particles 64 downward is formed at the other end (right end in FIG. 1) in the bottom surface 30b of the container 30.

Meshes (sieves) 32a, 32b, 32c are disposed in order from the downstream side toward the upstream side, on the upstream side with respect to the discharge port 30c in the bottom surface 30b of the container 30. Opening sizes (mesh sizes) of the meshes 32a, 32b, 32c are determined so as to prevent the medium particles 64 from passing and to permit the raw powder material to pass. The opening sizes decrease in the order of the meshes 32a, 32b, and 32c. The meshes may be replaced by perforated plates such as hole-punched plates.

Fractions of the resin powder 4a of the heavy powder having passed through the openings of the meshes 32a, 32b, 32c are recovered through respective lines L5, L6, L7 into recovery hoppers 91a, 91b, 91c, respectively.

There is no particular aperture on the bottom surface 30b on the upstream side of the mesh 32c.

Exhaust ports 30d for discharging gas containing the fiber 4b being the light powder from the interior of the container 30 are formed in the upper part of the container 30. The exhaust ports 30d are connected through a line L2 to the bug filter 70 and the fiber 4b in the gas is collected into a recovery hopper 92, while the gas is discharged to the outside. The bug filter is connected to a blower 72 to enable aspiration of gas from the interior of the container 30.

The gas blower unit 40 has a blower 41, gas blowing tubes 42, and blowing tube shakers (blowing tube shaking units) 43. Gas from the blower 41 is supplied through a line L3 to the gas blowing tubes 42. A large number of gas blowing tubes 42 are arranged in a matrix when the container 30 is viewed from top, as shown in FIG. 2. Namely, the gas blowing tubes 42 each are arranged to extend approximately in the vertical direction, a plurality of these tubes are juxtaposed in a direction of the unidirectional flow of the medium particles 64, and a plurality of these tubes are also juxtaposed in the horizontal direction intersecting with the unidirectional flow of medium particles 64.

Each gas blowing tube 42 is arranged to face the bottom surface 30b without any opening of the container 30, on the upstream side of the mesh 32c in the container 30. More specifically, the gas blowing tubes 42 are provided nearly in the central region of the container 30 in the horizontal direction in FIG. 1.

Each gas blowing tube 42 has a nozzle 42a for discharge of gas and the height of the nozzle 42a from the bottom surface 30b is so set that the nozzle 42a is kept inside a medium particle layer 65. In the present embodiment, the nozzles 42a face the bottom surface 30b. Preferably, the nozzles of the gas blowing tubes 42 are always put in the medium particle layer 65, at least, to the depth of 70% or more of a fill height of the medium particle layer 65. In the present embodiment, the gas blowing tubes 42 are straight tubes, but they may also be curved tubes, or gas blowing tubes each having a plurality of nozzles 42a. It is also possible to adopt nearly horizontal tubes each having a plurality of nozzles or a single nozzle and buried near the bottom surface 30b of the container.

Furthermore, the blowing tube shakers 43 for shaking the gas blowing tubes 42 are connected to the gas blowing tubes 42. The gas blowing tubes 42 are arranged nearly perpendicularly to the bottom surface 30b and preferred vibration directions of the gas blowing tubes 42 are directions perpendicular to the bottom surface 30b, directions parallel to the bottom surface 30b, or rotational motion to rotate around the axis perpendicular to the bottom surface 30b.

The blower 41, line L3, and gas blowing tubes 42 constitute the gas blower unit 40. The gas is preferably air. A blowing amount of the gas is so set as to discharge only the fiber being the light powder, to the outside of the medium particle layer 65. Since the medium particles 64 flow due to shaking, there is no need for supplying a large amount of gas as needed if the medium particle layer 65 is fluidized without shaking, and the gas amount can be defined as an amount enough for the fiber 4b to fly off from the medium particle layer 65.

The medium particle circulator 60 is a transfer device for transferring the medium particles 64 discharged from the discharge port 30c of the container 30, to the supply port 30e of the container 30 on a medium particle circulation line 62. For example, a bucket conveyor or the like can be used as the medium particle circulator 60.

Furthermore, the container 30 is supported by elastic supports 82, e.g., springs fixed to a pedestal 80 so that it can vibrate. Furthermore, the container shaker 50 fixed to the pedestal 80 is connected to the container 30 and the container 30 is vibrated thereby. Vibration directions of the container 30 are, for example, longitudinal directions (e.g., horizontal directions in FIG. 1, or the direction of flow of the medium particles 64 in the container 30), up and down directions (e.g., vertical directions or directions normal to the bottom surface 30b), directions normal to the plane of FIG. 1, or horizontal directions interesting with the direction of flow of the medium particles 64 in the container 30, or the like, and the vibration may also be circular motion around the vertical axis or the like.

There are no particular restrictions on the physical properties of the medium particles 64 as long as their particle sizes are larger than those of the raw powder material 4. Preferred particle sizes are approximately 0.5-2.0 mm. The medium particles 64 are preferably spherical particles. Materials suitably applicable are, for example, glass, silica, alumina, zirconia, iron, and so on.

A fill amount of the medium particle layer 65 is determined to achieve a height of ten or more times the particle sizes of medium particles 64, and, specifically, it is preferable, for example, to achieve a fill height of 1 cm or more.

The action of the powder separation apparatus 100 of this configuration will be described below.

First, the raw powder material 4 obtained by powdering the composite material containing the resin layer and the fiber layer, to 300 μm or less, preferably to 200 μm or less, is supplied into the raw material hopper 10. This raw powder material 4 is microscopically one in which the resin powder 4a and the fiber 4b are already mechanically separated from each other. Subsequently, this raw powder material 4 is pulverized by the crusher 20 to crush large aggregates or the like and then the raw powder material 4 is charged through the aperture 30a into the container 30. At the same time as it, the container 30 is shaken by the container shaker 50, and the medium particle circulator 60 creates the unidirectional flow of medium particles 64 from left to right in the drawing in the container 30.

With this, the medium particles 64 first come to flow due to vibration in the container 30. This results in pulverizing the raw powder material 4 due to collision with the medium particles 64 or the like. Specifically, it breaks adhesion between resin powders 4a, adhesion and tangling between fibers 4b, and adhesion and tangling between resin powder 4a and fiber 4b.

Furthermore, the resin powder 4a and fiber 4b unraveled in this manner are conveyed to the right in the drawing in accordance with the downward unidirectional flow of the medium particle layer 65.

Furthermore, when the raw powder material 4 arrives near the middle in the longitudinal direction of the container 30, the gas from the blowing tubes 42 transports the light powder, i.e., the fiber 4b having a relatively small terminal velocity Ut, and the fiber 4b is discharged with the gas upward from the medium particle layer 65. More specifically, the gas supplied from the nozzles 42a into the medium particle layer 65 is blocked by the bottom surface 30b whereby the gas flows mainly upward around the gas blowing tubes 42 in the medium particle layer 65. At this time, the fiber 4b becoming easier to fly off due to the crushing operation is discharged upward from the medium particle layer 65 as entrained in this gas.

Since the gas blowing tubes 42 are shaken by the blowing tube shaker 43, the effect of crushing the raw powder material by the medium particles 64 is extremely enhanced near the blowing tubes 42 to make the fiber 4b extremely easier to fly off, thereby improving the yield or separation accuracy of the fiber 4b.

Then the gas discharged with the fiber 4b of the light powder from the medium particle layer 65 is transported through the discharge ports 30d and line L2 to the bug filter 70, and the fiber 4b is recovered by the bug filter 70 to be stored in the recovery hopper 92.

On the other hand, the resin powder 4a of the light powder having a relatively large terminal velocity Ut and being unlikely to fly off is not blown off by the gas and, while remaining mainly in the bottom part of the medium particle layer 65, it moves further to the downstream on the flow of the medium particle layer 65. During passage above the meshes 32c, 32b, 32a, the resin powder 4a passable through their openings passes through the openings of the meshes to be classified according to particle sizes and to be recovered into the hoppers 91a, 91b, 91c, depending upon particle sizes. The medium particles 64 not passing through the meshes 32a, 32b, 32c are discharged from the discharge port 30c and fed back to the supply port 30e by the medium particle circulator 60.

In the powder separation apparatus 100 of the present embodiment, as described above, the vibration of the medium particles 64 sufficiently unravels the raw powder material 4 and the supply of gas into the medium particle layer 65 causes the unraveled fiber 4b to selectively fly off with the gas from the medium particle layer 65. Therefore, the resin powder 4a and the fiber 4b can be separated extremely accurately.

Since the circulated flow of the medium particles 64 is formed, it is easy to control the residence time of the raw powder material 4. Therefore, the raw powder material 4 can be crushed by the medium particles 64 in a sufficient period of time before the fiber 4b flies off with the gas, and the fiber 4b can be fully recovered by the gas from the blowing tubes 42 before recovery of the resin powder 4a through the mesh 32c and others.

When a plurality of gas blowing tubes 42 are arranged in the direction of the unidirectional flow of the medium particles, the discharge of the fiber 4b with the gas from the medium particle layer can be implemented in multiple stages, which can increase the efficiency of separation. Since the gas blowing tubes 42 are juxtaposed in the direction intersecting with the direction of the unidirectional flow, the separation is suitably effected in the container with the large width, which facilitates increase in disposal amount.

The meshes 32a, 32b, 32c provided in the bottom part permit the resin powder 4a of the heavy powder to be readily separated from the medium particles 64 and the resin powder can also be classified by the different mesh sizes of the meshes.

Since the bottom surface 30b of the container 30 is a ramp, it enables implementation of smooth circulation flow of medium particles 64.

Furthermore, since the raw powder material 4 is preliminarily crushed by the crusher 20 before charged into the container 30, there is no risk of mixture of large aggregate particles or the like into the container 30, which can improve the accuracy of separation more.

The resin powder precisely separated in this manner is suitably applicable as a recycled PVC material such as a recycled PVC compound and the fiber is also applicable, for example, pulp as a soil improvement agent or the like and fiber as a recycled resin material.

### Second Embodiment

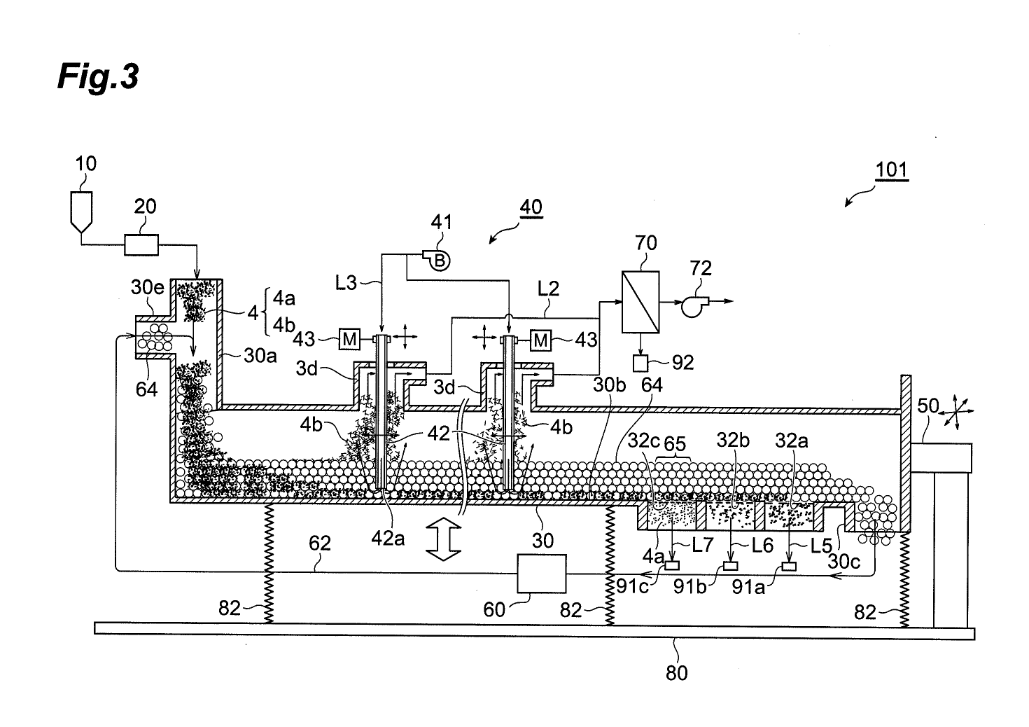

The second embodiment of the present invention will be described below with reference to FIG. 3. The powder separation apparatus 101 of the present embodiment is different from the first embodiment in that the bottom surface 30b of the container 30 is horizontal. The apparatus of this configuration is easy to manufacture. The present embodiment also achieves the action and effect similar to those in the first embodiment.

### Third Embodiment

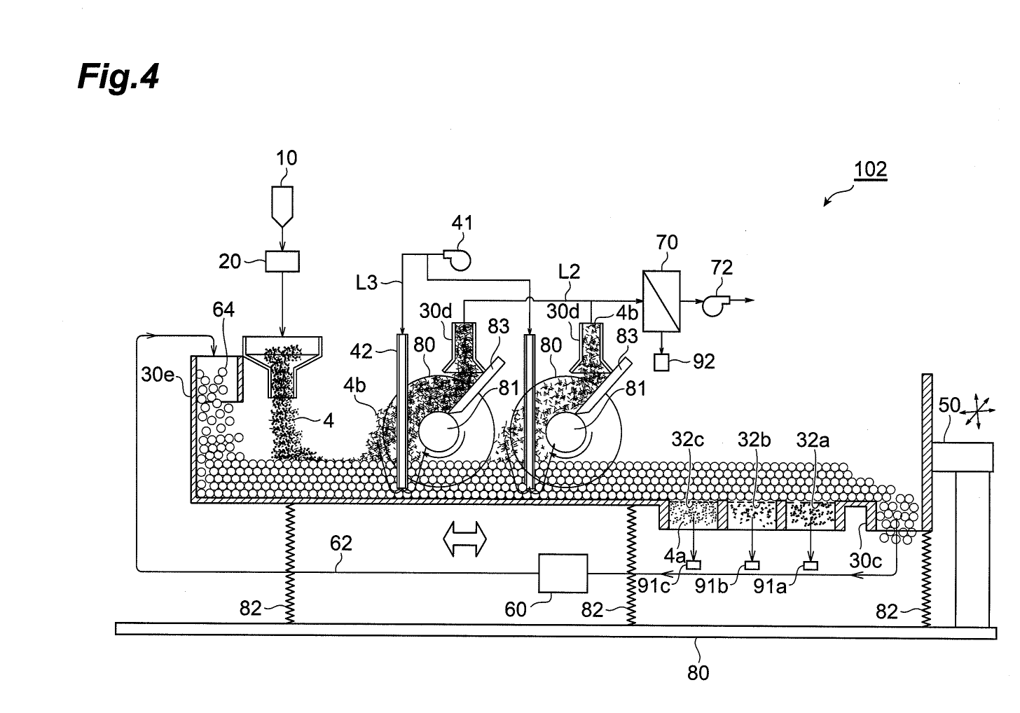

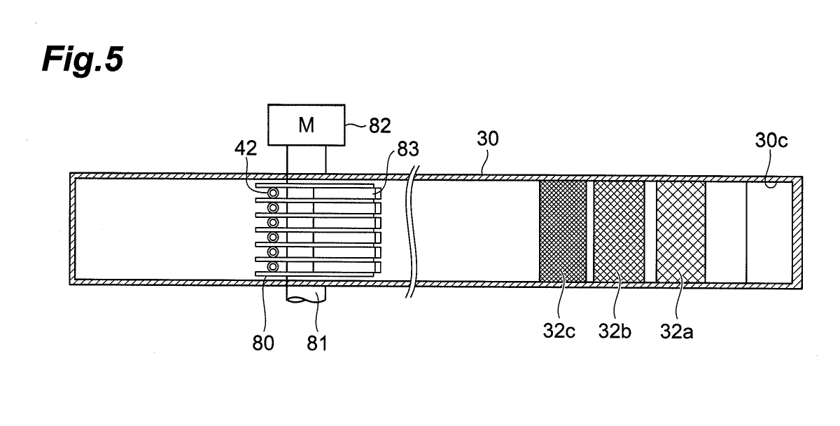

The third embodiment of the present invention will be described below with reference to FIGS. 4 and 5. The powder separation apparatus 102 of the present embodiment is different from the second embodiment in that the fiber 4b discharged from the medium particle layer 65 is made to adhere to charged plates 80 and aspirated to be recovered from there.

Specifically, the charged plates 70 of disk shape are arranged near the gas blowing tubes 42 and made of a material to be charged by friction with the medium particles 64 and others, or arranged to be charged by application of a voltage from the outside or the like. The charged plates 70 are rotated around horizontal shafts 81. The horizontal shafts 81 are arranged so that the lower part of the charged plates 70 penetrates in part in the medium particle layer 65. The horizontal shafts 81 are arranged in the horizontal direction intersecting with the direction of the unidirectional flow of medium particles 64. A plurality of charged plates 70 are provided on each horizontal shaft 81 so that the plurality of blowing tubes 42 arranged in the lateral direction are sandwiched each between two plates. Furthermore, this horizontal shaft 81 is also provided for each row of rear blowing tubes 42. Each horizontal shaft 81 is rotated in the illustrated direction or in the direction opposite to the direction of flow of medium particles 64 in the medium particle layer 65, by a motor 82. The material of the charged plates can be a metal sheet, a plastic sheet, or the like.

Scrapers 83 are arranged each between two charged plates 80 and in contact with the two charged plates 80 and with the peripheral surface of the horizontal shaft 81 so as to scrape off the fiber 4b electrostatically adhering to the charged plates 80, while being set on the stationary side free of rotation. A discharge port 30d is located above the scrapers 83 so as to aspirate the fiber 4b collected by the scrapers 83.

In the present embodiment, the fiber 4b is discharged to the outside of the medium particle layer 65 by the gas, is made to adhere electrostatically to the charged plates 80, and thereafter is recovered through the discharge ports 30d into the bug filter 70. Therefore, the present embodiment achieves the effect of efficiently performing recovery of the fiber 4b. The apparatus may be arranged in the structure wherein the bottom surface 30b of the container 30 is made as a ramp as in the case of the first embodiment.

### Fourth Embodiment

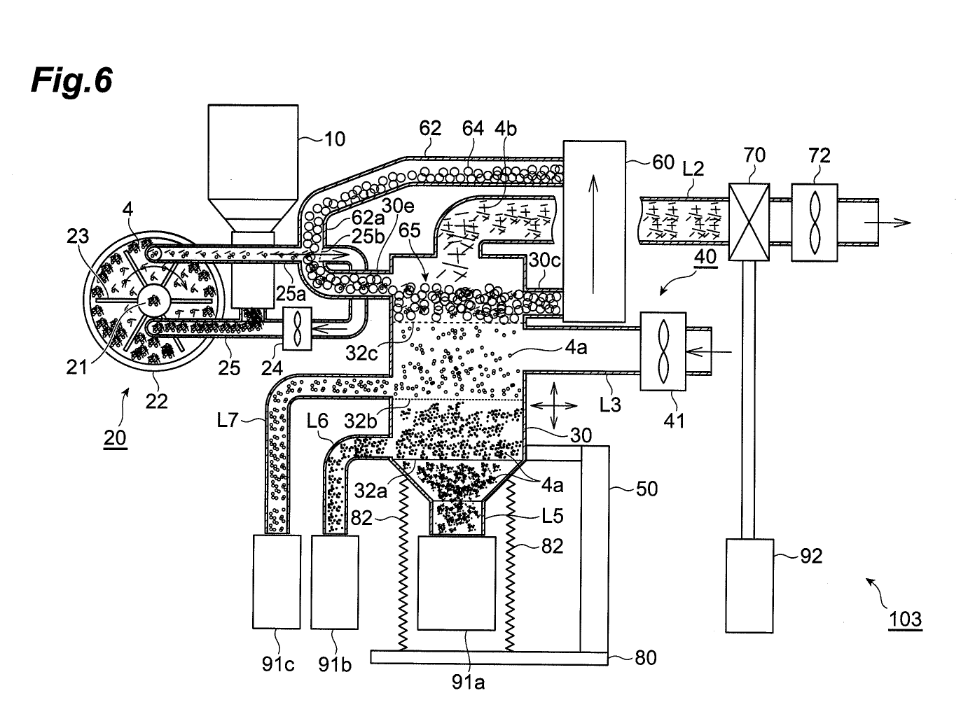

The powder separation apparatus 103 of the fourth embodiment of the present invention will be described below with reference to FIG. 6. In the present embodiment, the container 30 is of a vertical cylindrical shape and the meshes 32c, 32b, 32a are provided in order from top so as to partition the interior of the container 30 in the vertical direction.

The supply port 30e of medium particles 64 is located above the mesh 32c of the container 30 and the discharge port 30c of medium particles 64 is located above the mesh 32c of the container 30 and on the side opposite to the supply port 30e.

The line L3 is connected to the blower 41 for supplying gas into the medium particle layer 65 and is connected below the mesh 32c in the container 30 and, specifically, between the mesh 32c and the mesh 32b in the container 30. The medium particles 64 mixed with the raw powder material 4 are shaken on the mesh 32c in the container 30 by the container shaker 50 and made to flow in a unidirectional flow from left to right in the drawing on the mesh 32c by the medium particle circulator 60.

The gas from the blower 41 is supplied through the line L3 into the container 30 and then passes through the mesh 32c and the medium particle layer 65 to be supplied into the line L2. Since the medium particle layer 65 is fluidized by vibration, the space velocity of the gas in passage through the medium particle layer 65 may be sufficiently smaller than a quantity necessary for fluidization of the medium particle layer 65 without vibration.

In the present embodiment, the sufficient crushing effect on the mesh 32c also causes the fiber 4b to be discharged upward with the gas from the medium particle layer 65 to be recovered by the bug filter 70, while the resin powder 4a remaining in the medium particle layer 65 passes through the mesh 32c to drop, and is classified by the mesh 32b and the mesh 32a according to particle sizes to be stored through the lines L7, L6, L5 into the respective hoppers 91c, 91b, 91a.

The crusher 20 will be described in detail with reference to FIG. 6. The crusher 20 mainly has a horizontal rotational shaft 21 and a cylindrical barrel 22. A plurality of rotor blades 23 are arranged in the circumferential direction on the periphery of the horizontal rotational shaft 21. The rotor blades 23 can be, for example, round bars or the like. A material circulation line 25 with a blower 24 is connected to the barrel 22.

The raw material hopper 10 is connected to a downstream part with respect to the blower 24 in the material circulation line 25 and the raw powder material 4 from the raw material hopper 10 is supplied via the material circulation line 25 into the barrel 22 by an air current.

The upstream part of the material circulation line 25 with respect to the blower 24 is connected so as to intersect with the medium particle circulation line 62. Specifically, a vertical part 62a of the medium particle circulation line 62 is connected so as to intersect with a horizontal part 25a of the material circulation line 25. The raw powder material 4 crushed in the barrel 22 is entrained on the air current created by the blower 24, travels through the material circulation line 25, is trapped at the intersecting part by the medium particle layer 65 flowing down in the medium particle circulation line 62, and is transported with the medium particles 64 into the container 30. The remaining gas flows on the material circulation line 25 to transfer the raw powder material 4 from the raw material hopper 10 into the barrel 22. A mesh 25b is provided at an exit of the material circulation line 25 in the intersecting part between the medium particle circulation line 62 and the material circulation line 25, in order to prevent inflow of the medium particles 64 and the crushed raw powder material 4.

### Fifth Embodiment

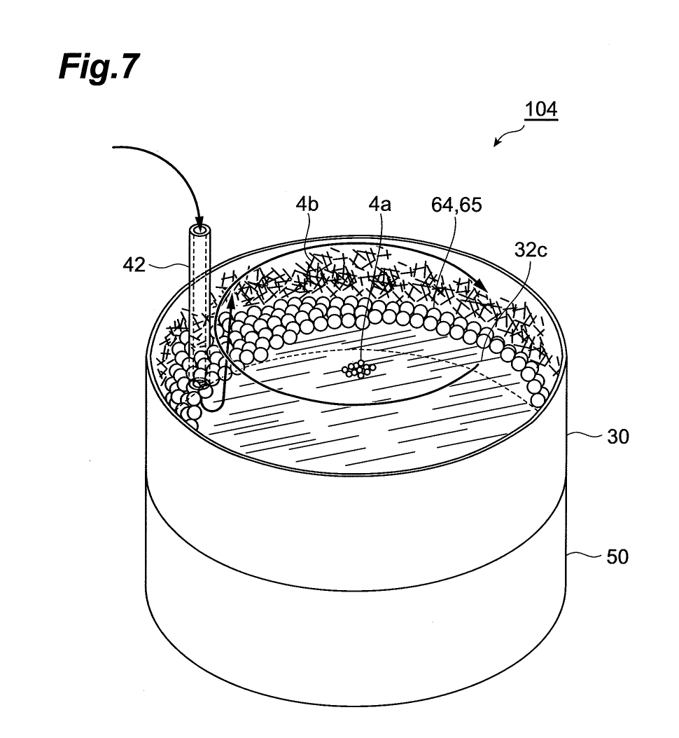

The fifth embodiment of the present invention will be described below with reference to FIG. 7. In the present embodiment, the container 30 is of a cylindrical dish shape and of a batch type without an exit for the resin powder 4a. The container 30 is shaken by the container shaker 50 such as a ro-tap shaker but may be shaken by hand or the like. Since the gas is also supplied from the gas blowing tube 42 in this powder separation apparatus 104, the fiber 4b of the light powder is discharged with the gas from the medium particle layer 65. The fiber 4b can be made to adhere to the wall of the container 30 by static electricity, depending upon conditions.

The present invention was described above based on the embodiments, but it is noted that the present invention is not limited to the above embodiments. For example, the above embodiments used the raw powder material containing the fiber of the light powder and the resin powder of the heavy powder, but, without having to be limited to this, the raw powder material may be any other powder material in which one particle material is lighter than the other particle material and easier to be discharged by wind, i.e., the terminal velocity Ut of one particle material is lower than that of the other particle material. For example, the raw powder material can be a mixture of a resin powder and a calcium carbonate powder having smaller particle sizes than those of the resin powder, or the like.

### EXAMPLE

In the powder separation apparatus 100 as shown in FIG. 1, a PVC wallpaper containing 65 parts by weight of a PVC layer and 35 parts by weight of paper (pulp fiber), was powdered to 300 μm or less.

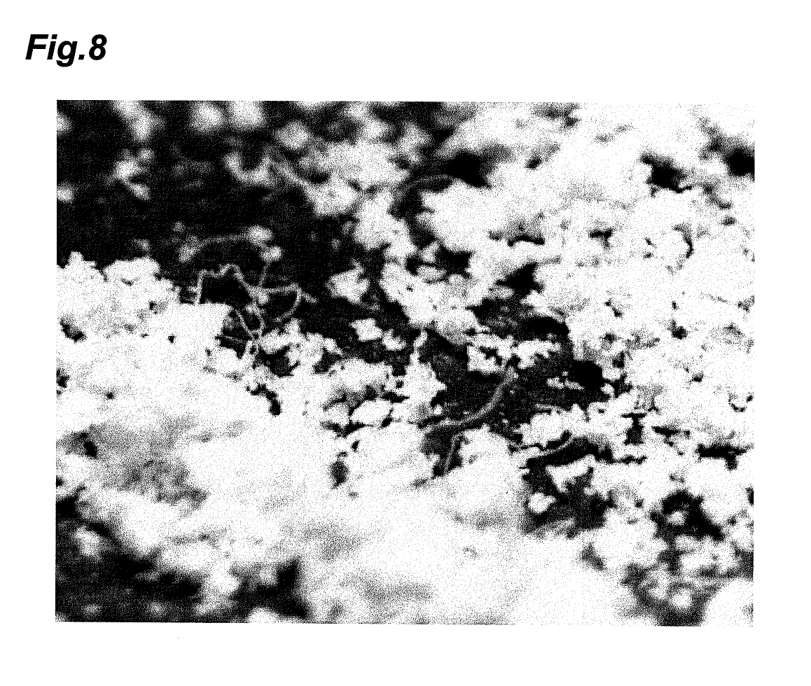

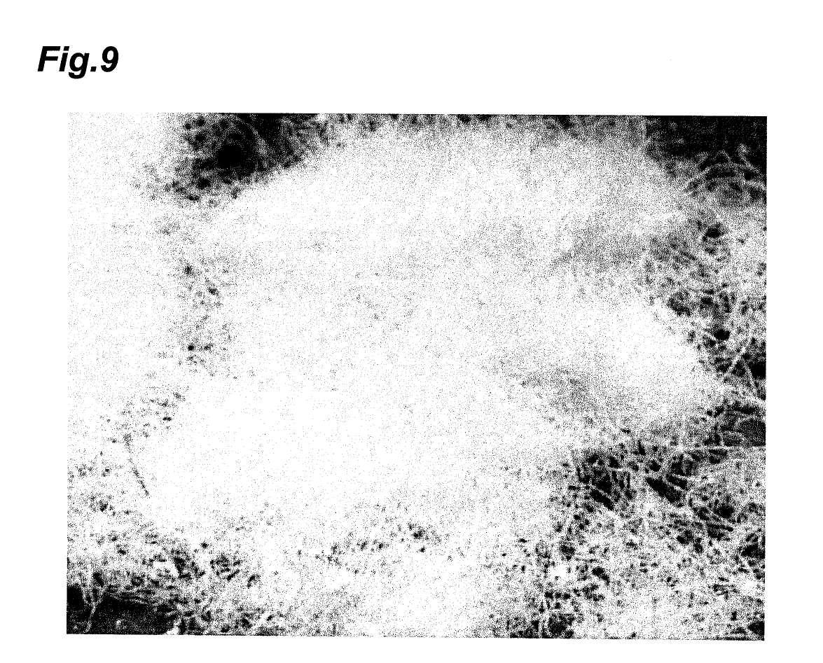

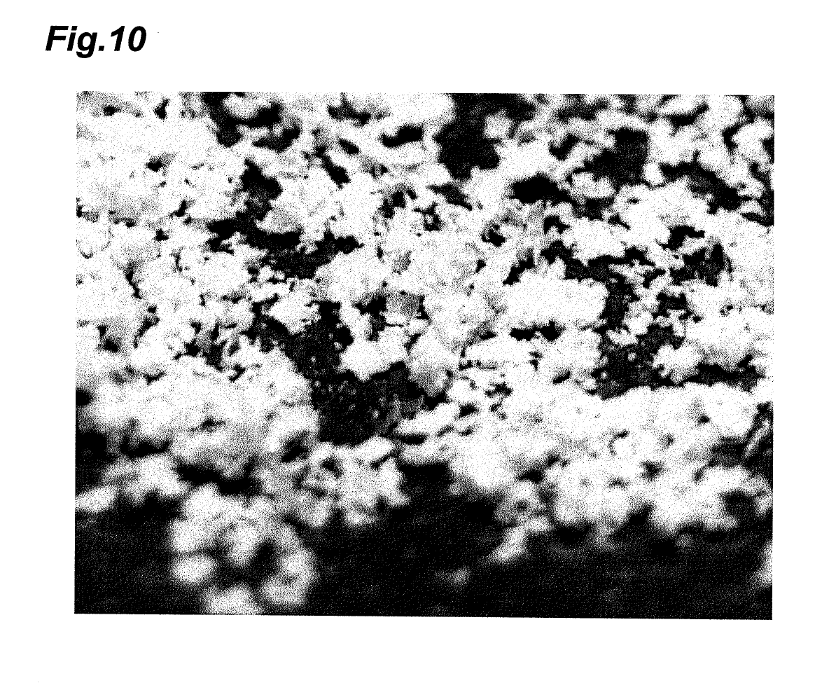

At the point of powering, 98 weight % or approximately 34.3 parts by weight of the paper was recovered by wind classification. After the recovery of 34.3 parts by weight of the paper, the crusher 20 was used to crush the raw powder material (cf. FIG. 8) containing 0.7 part by weight of the fiber resulting from the paper and 65 parts by weight of the resin powder and thereafter the raw powder material was supplied with glass medium particles of 1000 μm into the container 30 to be separated into the resin powder of heavy powder and the fiber of light powder with supply of gas. 0.63 part by weight of the fiber was recovered as the light powder and the purity of the resin powder recovered as the heavy powder was 99.9 wt %. FIG. 9 and FIG. 10 show respective microphotographs of the fiber as the light powder and the resin powder as the heavy powder after separated.

1. A powder separation apparatus comprising:
a container into which a raw powder material containing a heavy powder and a light powder, and medium particles having a larger particle size than the raw powder material, are supplied;
a container shaker for shaking the container; and
a gas blower unit for blowing a gas into an interior of a layer of the medium particles in the container to discharge the light powder with the gas to the outside of the layer of the medium particles.

2. The powder separation apparatus according to claim 1, further comprising a medium particle circulator for discharging the medium particles from one end side in the container to the outside of the container and for supplying the medium particles discharged from the container, to the other end side in the container to form a unidirectional flow of the medium particles in the container.

3. The powder separation apparatus according to claim 1, wherein the gas blower unit has a gas blowing tube a nozzle of which is inserted in the layer of the medium particles.

4. The powder separation apparatus according to claim 2, wherein the gas blower unit has a plurality of gas blowing tubes an opening of each of which is inserted in the layer of the medium particles, and
wherein the plurality of gas blowing tubes are juxtaposed in a direction of the unidirectional flow of the medium particles and/or the plurality of gas blowing tubes are juxtaposed in a direction intersecting with the direction of the unidirectional flow of the medium particles.

5. The powder separation apparatus according to claim 3, further comprising a gas blowing tube shaker for shaking the gas blowing tube.

6. The powder separation apparatus according to claim 2, wherein a bottom part on one end side of the container is provided with a sieve for preventing the medium particles from passing and for permitting the raw powder material to pass.

7. The powder separation apparatus according to claim 6, wherein the sieve comprises a plurality of sieve stages mesh sizes of which increase from upstream to downstream of the unidirectional flow of the medium particles.

8. The powder separation apparatus according to claim 2, wherein a bottom part of the container is a ramp inclined from upstream to downstream of the unidirectional flow of the medium particles.

9. The powder separation apparatus according to claim 1, wherein a sieve for preventing the medium particles from passing and for permitting the raw powder material to pass is provided in the container, and
wherein the gas blower unit supplies the gas upward through the sieve into the layer of the medium particles on the sieve.

10. The powder separation apparatus according to claim 9, wherein the container further has a sieve a mesh size of which is smaller than that of said sieve, below said sieve.

11. The powder separation apparatus according to claim 1, wherein the raw powder material is a powder of 300 μm or less containing a resin powder and a fiber.

12. The powder separation apparatus according to claim 1, further comprising a charged plate for electrostatically adsorbing the light powder discharged to the outside of the layer of the medium particles by the gas from the gas blower unit.

13. The powder separation apparatus according to claim 1, comprising a bug filter for collecting the light powder in the gas discharged from the container.

14. The powder separation apparatus according to claim 1, further comprising a crusher for preliminarily crushing the raw powder material to be supplied into the container.

15. A powder separation method comprising a step of vibrating a raw powder material containing a heavy powder and a light powder, and medium particles having a larger particle size than the raw powder material, in a container and blowing a gas into an interior of a layer of the medium particles in the container to discharge the light powder with the gas to the outside of the layer of the medium particles.
